(19) United States
(12) Patent Application Publication
(10) Pub. No.: US 2022/0164794 A1
(43) Pub. Date: May 26, 2022

(54) METHOD OF VERIFYING IDENTITY FOR A COMPUTERIZED ACCOUNT, COMPUTING DEVICE, AND STORAGE MEDIUM

(71) Applicant: HON HAI PRECISION INDUSTRY CO., LTD., New Taipei (TW)

(72) Inventor: YUHG-CHANG TAI, New Taipei (TW)

(21) Appl. No.: 17/533,366

(22) Filed: Nov. 23, 2021

(30) Foreign Application Priority Data
Nov. 24, 2020 (CN) 202011334837.1

(51) Int. Cl. G06Q 20/38; G06Q 20/40; H04L 9/06

(52) U.S. Cl. CPC G06Q 20/38215; G06Q 20/3827; H04L 2209/38; H04L 9/0643; H04L 2209/56; G06Q 20/4014

(57) ABSTRACT

A method of verifying identity for a computerized account, a computing device, and a storage medium are disclosed, the method obtains a username and searches for a verification address corresponding to the username according to a comparison table that records relationships between usernames and verification addresses. The verification address is stored on a blockchain network node, transaction information sent from an account address to the verification address is monitored through the verification address, and the account address is stored on the blockchain network node. If the transaction information sent to the verification address from an account address that matches the username, a prompt indicating that the username is successfully authenticated is sent to a user terminal corresponding to the username. The method enables identity verification in an efficient and a safe manner.

### FIELD

The present disclosure relates to a technical field of computer security, specifically a method of verifying identity for a computerized account, a computing device, and a storage medium.

### BACKGROUND

A combination of a username and a password can be used to verify user identity. Users need to register a username and a password corresponding to the username on each platform in advance. When the platform needs to verify the user's identity, the user confirms the identity through the registered username and password. An authentication based on the username and the password may be problematic. For example, users need to separately manage the username and password used by each platform. With increasing number of platforms, it may be difficult for users to remember and manage all of the login details. In addition, some platforms do not use encoding to display and record the password. Once the information is leaked or hacked, the password may be leaked and stolen.

### BRIEF DESCRIPTION OF THE DRAWINGS

FIG. 1 shows a schematic diagram of an application environment architecture of a method of verifying identity for a computerized account provided in an embodiment of the present disclosure.

FIG. 2 shows a flowchart of a method of verifying identity for a computerized account provided in an embodiment of the present disclosure.

FIG. 3 shows a schematic structural diagram of a device of verifying identity for a computerized account provided in an embodiment of the present disclosure.

FIG. 4 shows a schematic structural diagram of a computing device provided in an embodiment of the present disclosure.

### DETAILED DESCRIPTION

The accompanying drawings combined with the detailed description illustrate the embodiments of the present disclosure hereinafter. It is noted that embodiments of the present disclosure and features of the embodiments can be combined, when there is no conflict.

Various details are described in the following descriptions for a better understanding of the present disclosure, however, the present disclosure may also be implemented in other ways other than those described herein. The scope of the present disclosure is not to be limited by the specific embodiments disclosed below.

Unless defined otherwise, all technical and scientific terms used herein have the same meaning as commonly understood by one of ordinary skill in the art to which the present disclosure belongs. The terms used herein in the present disclosure are only for the purpose of describing specific embodiments and are not intended to limit the present disclosure.

Optionally, the method of verifying identity for a computerized account of the present disclosure is applied to one or more computing devices. The computing device includes hardware such as, but not limited to, a microprocessor and an Application Specific Integrated Circuit (ASIC), Field-Programmable Gate Array (FPGA), Digital Signal Processor (DSP), embedded devices, etc.

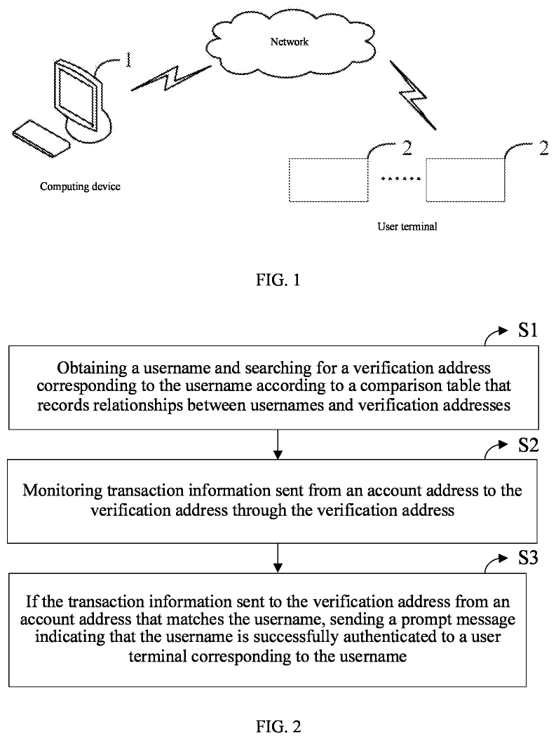

FIG. 1 is a schematic diagram of an application environment architecture of a method of verifying identity for a computerized account provided in an embodiment of the present disclosure.

The method of verifying identity for a computerized account of the present disclosure is applied to a computing device 1. The computing device 1 and at least one user terminal 2 establish a communication through a network. The network may be a wired network or a wireless network, such as a radio, a WI-FI, a cellular, a satellite, a broadcasting, etc. The computing device 1 is configured for a user to access an account by searching for a verification address corresponding to a username according to a comparison table that records relationships between usernames and verification addresses. Transaction information sent from an account address to the verification address is monitored through the verification address. When the transaction information from the account address is received, an operation corresponding to the transaction information is performed. The verification address and the account address are stored on a blockchain network node, and the account address has a relationship with the username.

The blockchain network is a decentralized storage and computing technology, which generates durable unmodifiable records by superimposing encrypted data blocks in chronological order, so that the verification address and the account address stored on the blockchain node are securely stored.

The blockchain network may be a public blockchain network, a consortium blockchain network or a private blockchain network. The public blockchain networks include, but are not limited to, a BITCOIN network and an ETHEREUM network. The blockchain networks includes, but is not limited to, a HYPERLEDGER network. The verification address and the account address may be stored on a same blockchain network or on different blockchain networks.

The computing device 1 may be an electronic device with an identity verification software installed, such as a personal computer, a server, etc. The server may be a single server, a server cluster, or a cloud server.

The user terminal 2 is any type of network user electronic device, including but not limited to a smart phone, a tablet computer, a laptop computer, a desktop computer, and the like.

FIG. 2 is a flowchart of a method of verifying identity for a computerized account in an embodiment of the present disclosure. The method is applied to computing devices. According to different needs, the order of the steps in the flowchart can be changed, and some can be omitted.

In block S1, obtaining a username and searching for a verification address corresponding to the username according to a comparison table that records relationships between usernames and verification addresses.

The verification address is stored on a blockchain network node.

In an embodiment of the present disclosure, the method for a computing device 1 to obtain the username includes receiving a login request from the username and responding according to the login request.

In some embodiments, before obtaining the username, the method further includes receiving the username and an account address and verifying validities of the received username and the received account address. The username and the account address together constitute a user account.

In some embodiments, the method of verifying identity for a computerized account includes querying the comparison table and verifying that the received username is valid when there is no username that is the same as the received username in the comparison table.

In some embodiments, the method of verifying identity for a computerized account includes querying the comparison table and verifying that the received account address is valid when there is no account address that is the same as the received account address in the comparison table.

When the received account address is valid, a hash value of the received account address is calculated through a preset algorithm, and the hash value is stored in the comparison table. The preset algorithm includes any one of a SHA224, a SHA256, a SHA384, a SHA512, a SHA1, a SHA2, or MD5.

When the received username and received account address are both valid, a verification address is assigned to the received username, and the assigned verification address, the received username, and the received account address are stored in the comparison table.

For example, a user terminal 2 submits a registration request to the computing device 1, and provides that a login username to be registered is Winner123 and an account address to be registered is 0xD60368063e2FE19806408b2A8760400a208D7e78. The computing device 1 searches the comparison table for whether there is a username that is the same as the username to be registered and whether there is an account address that is the same as the account address to be registered. When there is no username that is the same as the username to be registered and there is no account address that is the same as the username to be registered, it is determined that the username to be registered and the account address to be registered are valid. The computing device 1 sends a verification address 0xea674fdde714fd979de3edf0f56aa9716b898ec8 to the user terminal 2.

In block S2, monitoring transaction information sent from an account address to the verification address through the verification address.

If the computing device 1 obtains the username is Winner123, the account address corresponding to the username is 0xD60368063e2FE19806408b2A8760400a208D7e78, and the computing device 1 queries the comparison table according to the username Winner123 as 0xea674fdde714fd979de3edf0f56aa9716b898ec8. Then the computing device 1 monitors whether the verification address 0xea674fdde714fd979de3edf0f56aa9716b898ec8 receives the transaction information from the account address 0xD60368063e2FE19806408b2A8760400a208D7e78.

The account address is stored on the blockchain network node. There is a correspondence between the account address and the username. In an embodiment of the present disclosure, the same username may correspond to one or a plurality of account addresses, and different application functions may correspond to different account addresses according to differences in application functions of the transaction information. For example, a type of transaction information corresponding to a first account address is a financial transaction, a type of transaction information corresponding to a second account address is an entertainment, and a type of transaction information corresponding to a third account address is a public service.

For another example, account addresses can be classified according to application scenarios. For example, account addresses corresponding to entertainment are classified into a first type, and account addresses corresponding to learning scenarios are classified into a second type, and account addresses corresponding to purchase transactions are classified into a third type.

In block S3, if the transaction information sent to the verification address from an account address that matches the username, sending a prompt message indicating that the username is successfully authenticated to a user terminal corresponding to the username.

If the transaction information sent to the verification address from an account address that matches the username, it is determined that the username identity verification is successful, allowing the user to log in to the account and displaying information of the account.

In some embodiments, before sending the prompt message indicating that the username is successfully authenticated to a user terminal corresponding to the username, the method further includes: calculating a hash value of the account address, and comparing the calculated hash value with the hash value stored in the comparison table; if the calculated hash value is consistent with the hash value stored in the comparison table, generating the prompt message indicating that the username is successfully authenticated.

The account addresses provided in the embodiments of the present disclosure are all virtual wallet addresses.

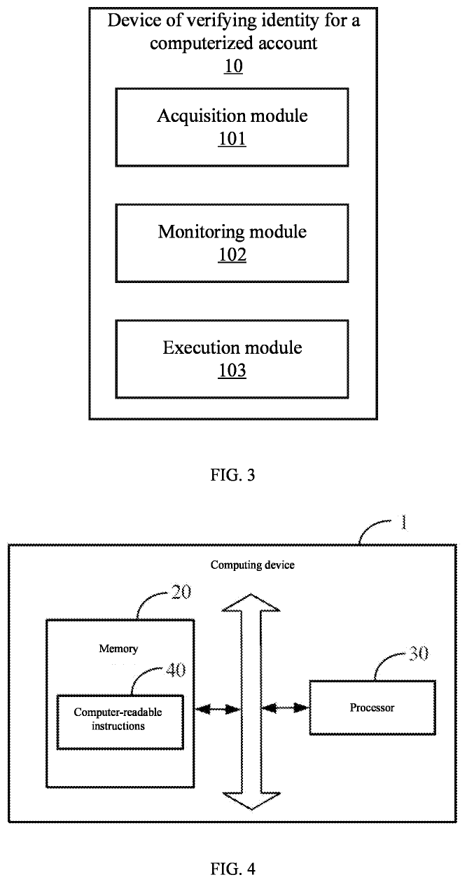

The above-mentioned FIG. 2 illustrates the method of verifying identity for a computerized account of the present disclosure in detail. With reference to FIGS. 3 and 4, the functional modules of the software device that implement the method of verifying identity for a computerized account and the hardware device architecture that implements the method of verifying identity for a computerized account are explained below.

FIG. 3 shows a schematic structural diagram of a device of verifying identity for a computerized account provided in the embodiment of the present disclosure.

In some embodiments, the device of verifying identity for a computerized account 10 runs in a computing device. The computing device is connected to a plurality of user terminals via a network. The device of verifying identity for a computerized account 10 can include a plurality of function modules consisting of program code segments. The program code of each program code segments in the device of verifying identity for a computerized account 10 can be stored in a memory and executed by at least one processor to perform functions of verifying identity for a computerized account.

As shown in FIG. 3, the device of verifying identity for a computerized account 10 can include: an acquisition module 101, a monitoring module 102, and an execution module 103. A module as referred to in the present disclosure refers to a series of computer-readable instruction segments that can be executed by at least one processor and that are capable of performing fixed functions, which are stored in a memory. In some embodiment, the functions of each module will be detailed.

The above-mentioned integrated unit implemented in a form of software functional modules can be stored in a non-transitory readable storage medium. The above software function modules are stored in a storage medium and includes several instructions for causing a computing device (which can be a personal computer, a dual-screen device, or a network device) or a processor to execute the method described in various embodiments in the present disclosure.

The acquisition module 101 obtains a username and searches for a verification address corresponding to the username according to a comparison table that records relationships between usernames and verification addresses.

The verification address is stored on a blockchain network node.

In an embodiment of the present disclosure, the acquisition module 101 obtaining the username includes receiving a login request from the username and responding according to the login request.

In some embodiments, the device of verifying identity for a computerized account 10 further receives a username and an account address and verifies validities of the received username and the received account address. The username and the account address together constitute a user account.

In some embodiments, wherein verifying validities of the received username includes querying the comparison table and verifying that the received username is valid when there is no username that is the same as the received username in the comparison table.

In some embodiments, wherein verifying validities of the received username includes querying the comparison table and verifying that the received account address is valid when there is no account address that is the same as the received account address in the comparison table.

When the received account address is valid, a hash value of the received account address is calculated through a preset algorithm, and the hash value is stored in the comparison table. The preset algorithm includes any one of a SHA224, a SHA256, a SHA384, a SHA512, a SHA1, a SHA2, or MD5.

When the received username and received account address are both valid, a verification address is assigned to the received username, and the assigned verification address, the received username, and the account address are stored in the comparison table.

For example, a user terminal 2 submits a registration request to the computing device 1, and provides that a username to be registered is Winner123 and an account address to be registered is 0xD60368063e2FE19806408b2A8760400a208D7e78. The computing device 1 searches the comparison table for whether there is a username that is the same as the username to be registered and whether there is an account address that is the same as the account address to be registered. When there is no username that is the same as the username to be registered and there is no account address that is the same as the username to be registered, it is determined that the username to be registered and the account address to be registered are valid. The computing device 1 sends a verification address 0xea674fdde714fd979de3edf0f56aa9716b898ec8 to the user terminal 2.

The monitoring module 102 monitors transaction information sent from an account address to the verification address through the verification address.

If the computing device 1 obtaining the username is Winner123, the account address corresponding to the username is 0xD60368063e2FE19806408b2A8760400a208D7e78, and the computing device 1 queries the comparison table according to the username Winner123 as 0xea674fdde714fd979de3edf0f56aa9716b898ec8. Then the computing device 1 monitors whether the verification address 0xea674fdde714fd979de3edf0f56aa9716b898ec8 receives the transaction information from the account address 0xD60368063e2FE19806408b2A8760400a208D7e78.

The account address is stored on the blockchain network node. There is a correspondence between the account address and the username. In an embodiment of the present disclosure, the same username may correspond to one or a plurality of account addresses, and different application functions may correspond to different account addresses according to differences in application functions of the transaction information. For example, a type of transaction information corresponding to a first account address is a financial transaction, a type of transaction information corresponding to a second account address is an entertainment, and a type of transaction information corresponding to a third account address is a public service.

For another example, account addresses can be classified according to application scenarios. For example, account addresses corresponding to entertainment are classified into a first type, and account addresses corresponding to learning scenarios are classified into a second type, and account addresses corresponding to purchase transactions are classified into a third type.

The execution module 103, if the transaction information sent to the verification address from an account address that matches the username, sends a prompt message indicating that the username is successfully authenticated to a user terminal corresponding to the username.

If the transaction information sent to the verification address from an account address that matches the username, it is determined that the username identity verification is successful, allowing the user to log in to the account and displaying information of the account.

In some embodiments, before sending the prompt message indicating that the username is successfully authenticated to a user terminal corresponding to the username, the execution module 103 further configured to: calculate a hash value of the account address, and compare the calculated hash value with the hash value stored in the comparison table; if the calculated hash value is consistent with the hash value stored in the comparison table, and generate the prompt message indicating that the username is successfully authenticated.

The account addresses provided in the embodiments of the present disclosure are all virtual wallet addresses.

The embodiment also provides a non-transitory readable storage medium having computer-readable instructions stored therein. The computer-readable instructions are executed by a processor to implement the steps in the above-mentioned method, such as in steps in blocks S1-S3 shown in FIG. 2:

In block S1, obtaining a username and searching for a verification address corresponding to the username according to a comparison table that records relationships between usernames and verification addresses;

In block S2, monitoring transaction information sent from an account address to the verification address through the verification address;

In block S3, if the transaction information sent to the verification address from an account address that matches the username, sending a prompt message indicating that the username is successfully authenticated to a user terminal corresponding to the username.

The computer-readable instructions are executed by the processor to realize the functions of each module/unit in the above-mentioned device embodiments, such as the modules 101-103 in FIG. 3:

The acquisition module 101 obtains a username and searches for a verification address corresponding to the username according to a comparison table that records relationships between usernames and verification addresses;

The monitoring module 102 monitors transaction information sent from an account address to the verification address through the verification address;

The execution module 103, if the transaction information sent to the verification address from an account address that matches the username, sends a prompt message indicating that the username is successfully authenticated to a user terminal corresponding to the username.

FIG. 4 is a schematic structural diagram of a computing device provided in an embodiment of the present disclosure. The computing device 1 may include: a memory 20, at least one processor 30, and computer-readable instructions 40 stored in the memory 20 and executable on the at least one processor 30, for example, image recognition programs. The processor 30 executes the computer-readable instructions 40 to implement the steps in the embodiment of the method of verifying identity for a computerized account, such as in steps in block S1-S3 shown in FIG. 2. Alternatively, the processor 30 executes the computer-readable instructions 40 to implement the functions of the modules/units in the foregoing device embodiments, such as the modules 101-103 in FIG. 3.

For example, the computer-readable instructions 40 can be divided into one or more modules/units, and the one or more modules/units are stored in the memory 20 and executed by the at least one processor 30. The one or more modules/units can be a series of computer-readable instruction segments capable of performing specific functions, and the instruction segments are used to describe execution processes of the computer-readable instructions 40 in the computing device 1. For example, the computer-readable instructions can be divided into the acquisition module 101, the monitoring module 102, and the execution module 103 as in FIG. 3.

The computing device 1 can be a computing device such as a desktop computer, a notebook, a palmtop computer, and a cloud server. Those skilled in the art will understand that the schematic diagram 4 is only an example of the computing device 1 and does not constitute a limitation on the computing device 1. Another computing device 1 may include more or fewer components than shown in the figures or may combine some components or have different components. For example, the computing device 1 may further include an input/output device, a network access device, a bus, and the like.

The at least one processor 30 can be a central processing unit (CPU), or can be another general-purpose processor, digital signal processor (DSPs), application-specific integrated circuit (ASIC), Field-Programmable Gate Array (FPGA), another programmable logic device, discrete gate, transistor logic device, or discrete hardware component, etc. The processor 30 can be a microprocessor or any conventional processor. The processor 30 is a control center of the computing device 1 and connects various parts of the entire computing device 1 by using various interfaces and lines.

The memory 20 can be configured to store the computer-readable instructions 40 and/or modules/units. The processor 30 may run or execute the computer-readable instructions 40 and/or modules/units stored in the memory 20 and may call up data stored in the memory 20 to implement various functions of the computing device 1. The memory 20 mainly includes a storage program area and a storage data area. The storage program area may store an operating system, and an application program required for at least one function (such as a sound playback function, an image playback function, etc.), etc. The storage data area may store data (such as audio data, phone book data, etc.) created according to the use of the computing device 1. In addition, the memory 20 may include a high-speed random access memory, and may also include a non-transitory storage medium, such as a hard disk, an internal memory, a plug-in hard disk, a smart media card (SMC), a secure digital (SD) Card, a flashcard, at least one disk storage device, a flash memory device, or another non-transitory solid-state storage device.

When the modules/units integrated into the computing device 1 are implemented in the form of software functional units having been sold or used as independent products, they can be stored in a non-transitory readable storage medium. Based on this understanding, all or part of the processes in the methods of the above embodiments implemented by the present disclosure can also be completed by related hardware instructed by computer-readable instructions 40. The computer-readable instructions can be stored in a non-transitory readable storage medium. The computer-readable instructions, when executed by the processor, may implement the steps of the foregoing method embodiments. The computer-readable instructions include computer-readable instruction codes, and the computer-readable instruction codes can be in a source code form, an object code form, an executable file, or some intermediate form. The non-transitory readable storage medium can include any entity or device capable of carrying the computer-readable instruction code, such as a recording medium, a U disk, a mobile hard disk, a magnetic disk, an optical disk, a computer memory, or a read-only memory (ROM).

In the several embodiments provided in the preset application, the disclosed computing device and method can be implemented in other ways. For example, the embodiments of the devices described above are merely illustrative. For example, divisions of the units are only logical function divisions, and there can be other manners of division in actual implementation.

In addition, each functional unit in each embodiment of the present disclosure can be integrated into one processing unit, or can be physically present separately in each unit or two or more units can be integrated into one unit. The above modules can be implemented in a form of hardware or in a form of a software functional unit.

The present disclosure is not limited to the details of the above-described exemplary embodiments, and the present disclosure can be embodied in other specific forms without departing from the spirit or essential characteristics of the present disclosure. Therefore, the present embodiments are to be considered as illustrative and not restrictive, and the scope of the present disclosure is defined by the appended claims. All changes and variations in the meaning and scope of equivalent elements are included in the present disclosure. Any reference sign in the claims should not be construed as limiting the claim. Furthermore, the word “comprising” does not exclude other units nor does the singular exclude the plural. A plurality of units or devices stated in the system claims may also be implemented by one unit or device through software or hardware. Words such as “first” and “second” are used to indicate names, but not in any particular order.

Finally, the above embodiments are only used to illustrate technical solutions of the present disclosure and are not to be taken as restrictions on the technical solutions. Although the present disclosure has been described in detail with reference to the above embodiments, those skilled in the art should understand that the technical solutions described in one embodiment can be modified, or some of the technical features can be equivalently substituted, and that these modifications or substitutions are not to detract from the essence of the technical solutions or from the scope of the technical solutions of the embodiments of the present disclosure.

What is claimed is:

1. A method of verifying identity for a computerized account, the method comprising:
obtaining a username and searching for a verification address corresponding to the username according to a comparison table that records relationships between usernames and verification addresses, and the verification address is stored on a blockchain network node;
monitoring transaction information sent from an account address to the verification address through the verification address, the account address is stored on the blockchain network node; and
if the transaction information sent to the verification address from an account address that matches the username, sending a prompt message indicating that the username is successfully authenticated to a user terminal corresponding to the username.

2. The method according to claim 1, the method further comprising:
receiving a username and an account address, and verifying validities of the received username and the received account address; wherein
if the received username and received account address are valid, assigning a verification address to the received username, and correspondingly storing the assigned verification address, the received username, and the received account address in the comparison table.

3. The method according to claim 2, wherein verifying validities of the received username and the received account address comprises:
querying the comparison table;
verifying that the received username is valid when there is no username that is the same as the received username in the comparison table; and
verifying that the received account address is valid when there is no account address that is the same as the received account address in the comparison table.

4. The method according to claim 2, the method further comprising:
calculating a hash value of the received account address through a preset algorithm, and correspondingly storing the hash value in the comparison table, wherein the preset algorithm comprises a SHA224, a SHA256, a SHA384, a SHA512, a SHA1, a SHA2, or MD5.

5. The method according to claim 4, the method further comprising:
calculating a hash value of the account address, and comparing the calculated hash value with the hash value stored in the comparison table, before sending the prompt message indicating that the username is successfully authenticated to a user terminal corresponding to the username; wherein
if the calculated hash value is consistent with the hash value stored in the comparison table, generating the prompt message indicating that the username is successfully authenticated.

6. The method according to claim 1, wherein the relationships between usernames and verification addresses comprises: one username corresponds to at least one account address, different application functions correspond to different account addresses according to differences in application functions of transaction information.

7. The method according to claim 1, wherein the account addresses are virtual wallet addresses.

8. A computing device comprising a memory and a processor, the memory stores at least one computer-readable instruction, which when executed by the processor causes the processor to:
obtain a username and search for a verification address corresponding to the username according to a comparison table that records relationships between usernames and verification addresses, and the verification address is stored on a blockchain network node;
monitor transaction information sent from an account address to the verification address through the verification address, the account address is stored on the blockchain network node;
if the transaction information sent to the verification address from an account address that matches the username, send a prompt message indicating that the username is successfully authenticated to a user terminal corresponding to the username.

9. The computing device according to claim 8, wherein the processor is further caused to:
receive a username and an account address, and verifying validities of the received username and the received account address; wherein
if the received username and received account address are valid, assign a verification address to the received username, and correspondingly store the assigned verification address, the received username, and the received account address in the comparison table.

10. The computing device according to claim 9, wherein the processor verifying validities of the received username and the received account address by:
querying the comparison table;
verifying that the received username is valid when there is no username that is the same as the received username in the comparison table; and
verifying that the received account address is valid when there is no account address that is the same as the received account address in the comparison table.

11. The computing device according to claim 9, wherein the processor is further caused to:
calculate a hash value of the received account address through a preset algorithm, and correspondingly store the hash value in the comparison table, wherein the preset algorithm comprises a SHA224, a SHA256, a SHA384, a SHA512, a SHA1, a SHA2, or MD5.

12. The computing device according to claim 11, wherein the processor is further caused to:
calculate a hash value of the account address, and comparing the calculated hash value with the hash value stored in the comparison table, before sending the prompt message indicating that the username is successfully authenticated to a user terminal corresponding to the username; wherein
if the calculated hash value is consistent with the hash value stored in the comparison table, generate the prompt message indicating that the username is successfully authenticated.

13. The computing device according to claim 8, wherein the relationships between usernames and verification addresses comprises: one username corresponds to at least one account address, different application functions correspond to different account addresses according to differences in application functions of transaction information.

14. The computing device according to claim 8, wherein the account addresses are virtual wallet addresses.

15. A non-transitory storage medium having stored thereon at least one computer-readable instructions that, when the at least one computer-readable instructions are executed by a processor to implement a method of verifying identity for a computerized account, which comprises:
obtaining a username and searching for a verification address corresponding to the username according to a comparison table that records relationships between usernames and verification addresses, and the verification address is stored on a blockchain network node;
monitoring transaction information sent from an account address to the verification address through the verification address, the account address is stored on the blockchain network node; and
if the transaction information sent to the verification address from an account address that matches the username, sending a prompt message indicating that the username is successfully authenticated to a user terminal corresponding to the username.

16. The non-transitory storage medium according to claim 15, wherein the method further comprises:
receiving a username and an account address, and verifying validities of the received username and the received account address; wherein
if the received username and received account address are valid, assigning a verification address to the received username, and correspondingly storing the assigned verification address, the received username, and the received account address in the comparison table.

17. The non-transitory storage medium according to claim 16, wherein verifying validities of the received username and the received account address comprises:
querying the comparison table;
verifying that the received username is valid when there is no username that is the same as the received username in the comparison table; and
verifying that the received account address is valid when there is no account address that is the same as the received account address in the comparison table.

18. The non-transitory storage medium according to claim 16, wherein the method further comprises:
calculating a hash value of the received account address through a preset algorithm, and correspondingly storing the hash value in the comparison table, wherein the preset algorithm comprises a SHA224, a SHA256, a SHA384, a SHA512, a SHA1, a SHA2, or MD5.

19. The non-transitory storage medium according to claim 18, wherein the method further comprises:
calculating a hash value of the account address, and comparing the calculated hash value with the hash value stored in the comparison table, before sending the prompt message indicating that the username is successfully authenticated to a user terminal corresponding to the username; wherein
if the calculated hash value is consistent with the hash value stored in the comparison table, generating the prompt message indicating that the username is successfully authenticated.

20. The non-transitory storage medium according to claim 15, wherein the relationships between usernames and verification addresses comprises: one username corresponds to at least one account address, different application functions correspond to different account addresses according to differences in application functions of transaction information.
